(19) United States
(12) Patent Application Publication
(10) Pub. No.: US 2009/0243856 A1
(43) Pub. Date: Oct. 1, 2009

(54) SYSTEM FOR MANAGING CHEMICALS USING RFID

(75) Inventors: Sang Mok Lee, Suyeong-gu (KR); Kun Sang Park, Goyang-si (KR); Woo Sung Kim, Haeundae-gu (KR); Ho Il Kang, Goyang-si (KR); Chang Hee Lee, Yeongdo-gu (KR); Dong Kil Lim, Saha-gu (KR); Yong Suk Ko, Jeonju-si (KR); So Hee Kim, Seocho-gu (KR); Dae Hyun Jo, Yangcheon-gu (KR); Dai Byung Kim, Dongjak-gu (KR); Won Gon Yoo, Songpa-gu (KR)

Correspondence Address: MERCHANT & GOULD PC, P.O. BOX 2903, MINNEAPOLIS, MN, 55402-0903, US

(73) Assignee: REPUBLIC OF KOREA (KOREA FOOD & DRUG ADMINISTRATION), Eunpyeon-gu (KR)

(21) Appl. No.: 12/261,874

(22) Filed: Oct. 30, 2008

(30) Foreign Application Priority Data
Dec. 3, 2007 (KR) 10-2007-0124198

(51) Int. Cl. G08B 13/14; H04Q 5/22

(52) U.S. Cl. 340/572.1; 340/10.1

(57) ABSTRACT

Disclosed herein is a system for managing chemicals using Radio-Frequency Identification (RFID). A storage facility identification tag, attached to a chemical storage facility in a laboratory, stores the unique identification code of the chemical storage facility and a list of chemicals. A chemical identification tag, attached to the cover of a chemical container, stores the unique identification code of the chemical storage facility and chemical-related information. A mobile terminal, provided with an RFID reader, receives and outputs the unique identification code of the chemical storage facility, the list of the chemicals, and the chemical-related information. A chemical management server receives information, stores the chemical-related information, manages the use details and inventory quantity of the chemical, checks the storage location of the chemical container and provides warning when the storage location of the chemical container is wrong, and provides warning and information about countermeasures when a danger situation occurs.

This application claims benefit of Serial No. 10-2007-0124198, filed 3 Dec. 2007 in Korea and which application is incorporated herein by reference. To the extent appropriate, a claim of priority is made to the above disclosed application.

### BACKGROUND OF THE INVENTION

1. Field of the Invention

The present invention relates generally to a system for managing chemicals, and, more particularly, to a system for managing chemicals using Radio-Frequency Identification (RFID), which can perform overall management of chemicals in a laboratory, such as information management, use details management, inventory management and effective period management for chemicals, and which can perform chemical storage location management and danger management in the laboratory.

2. Description of the Related Art

In general, a plurality of chemical storage facilities is provided in a chemistry-related laboratory, and a plurality of chemicals is kept in each of the chemical storage facilities. After the chemicals are drawn from the corresponding chemical storage facility and then used according to the necessity of testers, the chemicals are disposed to their original locations and then kept for a long time.

Conventionally, a list of chemicals, written by hand, is provided so as to manage the chemicals in a laboratory, and a chemical manager checks chemicals kept in the laboratory one by one with his/her naked eyes and then compares the chemicals with details written in the list of chemicals, thereby performing management of chemicals. In the case of searching for a desired chemical, configuration is set such that a location in which the corresponding chemical is kept can be found by checking the list of chemicals. However, the conventional method has disadvantages in that a list of entire chemicals must be checked in order to search for a specific chemical, and in that, when a chemical is kept in a wrong location which is different from the location written in the list of chemicals by mistake, a long time period is required for searching for the corresponding chemical.

Further, when inventory is periodically checked, there is a disadvantage in that a chemical manager must check chemicals one by one with his/her naked eyes and then recognize inventory quantity.

Meanwhile, since chemicals used in a laboratory have unique chemical characteristics, there is a plurality of chemicals which must be actively attended to in storage. For example, when acid and alkali react with each other and then are neutralized, they generate a heat of neutralization, thereby creating the danger of fire. Therefore, an acid chemical must not be kept together with a basic chemical in a close range. Since alkali metal intensely reacts with water and then generates hydrogen, explosions may occur. Therefore, they must not be kept close together. Further, since formaldehyde reacts with hydrochloric acid and then generates carcinogenic substances, it is dangerous to keep them close together.

However, according to the conventional method of managing chemicals, it is difficult to separate chemicals or isolate and then keep the chemicals in consideration of the chemical characteristics of the respective chemicals. In particular, with regard to chemicals which have been separated, isolated and then kept based on a predetermined reference, if the chemicals were kept in wrong locations owing to the tester's carelessness, the danger of fire or explosion may occur, so that the conventional method is inapplicable. Further, since it is difficult to search for one or more chemicals which are placed in the wrong locations, it is difficult to prevent danger in advance.

Further, in the case of the management of psychotropic medicines such as narcotics, it is difficult to search for the culprit when medicines go lost. There is a plurality of chemicals which must be kept at a specific temperature so as to maintain the quality thereof, and the storage temperature history of each of the chemicals is an item which is connected directly with the analysis of quality, so that it is essential to trace the history thereof. However, there has been no conventional method of tracing storage temperature history.

In order to solve these problems in the conventional method of managing chemicals, a method of managing chemicals by attaching barcodes to the respective chemicals has been proposed. However, each of the barcodes has the characteristic in that it can be recognized only when it comes into contact with a reader, and in that a recognition task is possible only by the one-to-one correspondence of a barcode and a reader. Therefore, there are still disadvantages in that management efficiency is deteriorated and the problems of location management and danger management regarding chemicals have not been solved.

### SUMMARY OF THE INVENTION

Accordingly, the present invention has been made keeping in mind the above problems occurring in the conventional method of managing chemicals, and an object of the present invention is to provide a system for managing chemicals using RFID, which can perform overall management of chemicals, such as information management, management of use details, inventory management and effective period management for the chemicals, and which can perform chemical storage location management and danger management in a laboratory.

The object and advantages of the present invention will be more clearly described below, and realized through embodiments. Further the object and advantages of the present invention can be realized through units and the combination thereof disclosed in the claims.

In order to accomplish the above object, the present invention provides a system for managing chemicals using Radio-Frequency Identification (RFID), including a storage facility identification tag configured to be attached to each of chemical storage facilities in a laboratory, and to store a unique identification code for identifying the chemical storage facility and a list of chemicals stored in the chemical storage facility, the storage facility identification tag being an RFID tag; a chemical identification tag configured to be attached to the cover of each of chemical containers kept in the chemical storage facility, and to store the unique identification code of the chemical storage facility, in which relevant chemicals should be kept, and chemical-related information, the chemical identification tag being an RFID tag; a mobile terminal provided with an RFID reader, and configured to receive and output the unique identification code of the chemical storage facility and the list of the chemicals, stored in the storage facility identification tag, and the unique identification code of the chemical storage facility and the chemical-related information, stored in the chemical identification tag; and a chemical management server connected with the mobile terminal over a network, and configured to receive information recognized based on the storage facility identification tag and the chemical identification tag, to store the chemical-related information for the chemical, to manage the use details and inventory quantity of the chemical, to check the storage location of the chemical container and provide a warning when the storage location of the chemical container is wrong, and to provide a warning and information about countermeasures when a danger situation occurs.

Here, the chemical management server includes a chemical information management module for receiving the chemical-related information stored in the chemical identification tag from the mobile terminal which has recognized the chemical identification tag, and storing the chemical-related information in a chemical information Database (DB) and then managing it; a location management module for receiving the unique identification code of the chemical storage facility and the list of the chemicals in the chemical storage facility, which are stored in the storage facility identification tag, and the unique identification code of the chemical storage facility, which is stored in the chemical identification tag, from the mobile terminal, storing them in a location management information DB and then managing them, and generating a warning signal when a chemical is not located at a desired location; an inventory management module for managing the inventory quantity, use details and effective period of each of the chemicals based on data stored in the chemical information DB; and a danger management module for storing classification reference data for chemicals which must not be kept together in a same place for the purpose of safe storage and danger management of the chemicals in a danger management information DB and then managing it, and generating a warning signal when one or more chemicals are kept in a state in which they are inconsistent with the classification reference stored in the danger management information DB.

Further, when a new event, such as the use, replacement or location change of a specific chemical, occurs, the mobile terminal receives data, such as the amount of used chemical, information about the replaced chemical or information about the changed location of the chemical, transmits the received data to the storage facility identification tag, the chemical identification tag, and the chemical management server, and then performs an update.

In addition, the chemical storage facility further includes a storage facility terminal for recognizing the chemical identification tag and, when the chemical container is put into or drawn from the chemical storage facility, detecting the entry and exit and then notifying the chemical management server of the entry and exit in real time, recognizing a user identification card, provided with an RFID tag for storing the personal information of a chemical user, and allowing the door of the chemical storage facility to be selectively opened and closed, and transmitting the recognized personal information of the chemical user to the chemical management server in real time.

Furthermore, the chemical management server includes an entry and exit management module for storing the personal information of the user, which is received from the storage facility terminal, and a time, at which a specific chemical is put into and drawn from the chemical storage facility, in an entry and exit management information DB and then managing them.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing a system for managing chemicals using RFID according to the present invention; and

FIG. 2 is diagram showing the configuration of the server of the system for managing chemicals using RFID according to the present invention.

### DESCRIPTION OF THE PREFERRED EMBODIMENTS

Reference now should be made to the drawings, in which the same reference numerals are used throughout the different drawings to designate the same or similar components.

The configuration and operation of a system for managing chemicals using RFID according to the present invention will be described in detail with reference to the attached drawings.

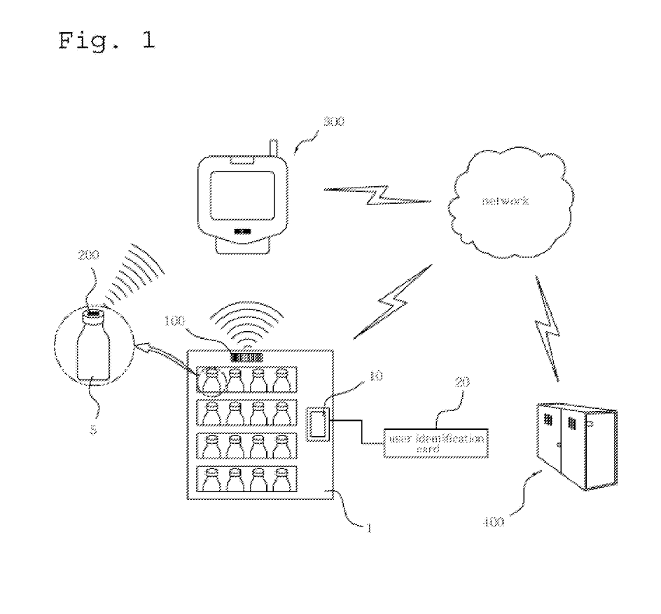

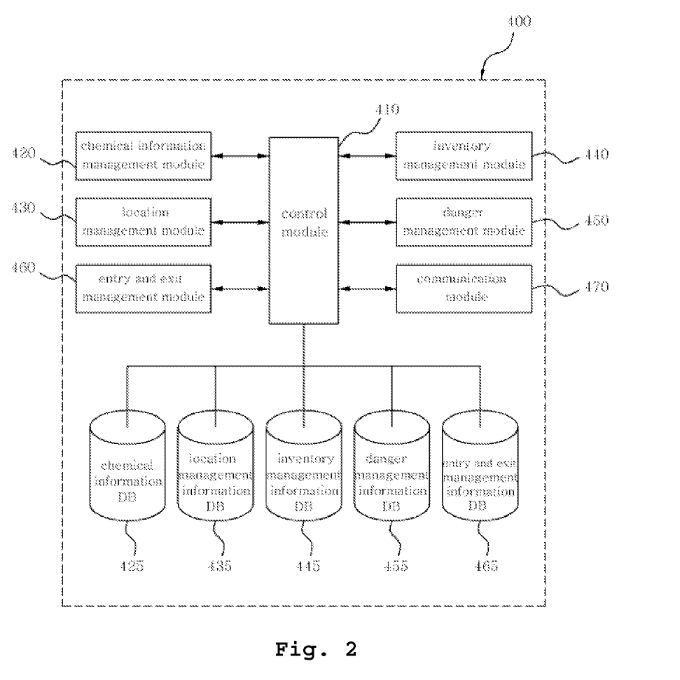

FIG. 1 is a schematic diagram showing a system for managing chemicals using RFID according to the present invention. FIG. 2 is diagram showing the configuration of the server of the system for managing chemicals using RFID according to the present invention.

As shown in the drawings, the system for managing chemicals using RFID according to the present invention includes a storage facility identification tag 100, a plurality of chemical identification tags 200, a mobile terminal 300, and a chemical management server 400. The mobile terminal 300 is connected to the chemical management server 400 over a network.

The storage facility identification tag 100 is an RFID tag attached to a chemical storage facility 1, in which various chemical containers 5 are stored, in a laboratory. The storage facility identification tag 100 previously stores a unique identification code, used to identify the specific chemical storage facility 1, and a list of chemicals stored in the chemical storage facility 1. Further, it is preferable that the storage facility identification tag 100 store information about the standard of the storage facility or information about the temperature of the storage facility so as to enable management of history concerning a storage environment for a chemical to be performed.

Here, the unique identification code of the chemical storage facility 1 is similar to a library number (a number indicating the location of a library in which a specific book is kept) which is assigned for easy searching for a specific book in a library, and may include the unique number of the chemical storage facility 1 located in the laboratory, and location information assigned after the inside of the chemical storage facility, having the unique number, is divided into a plurality of districts. For example, the unique identification code of a first storage facility which is located in the right side of a laboratory ‘A’ may be assigned as ‘AR1’. As long as the location of the chemical storage facility 1 can be specified, the unique identification code of the chemical storage facility 1 can be freely set by determining various references without limitations on the format thereof in consideration of the size of the laboratory and the number of storage facilities. Meanwhile, it is preferable that a list of chemicals, stored in the storage facility identification tag 100, be written using chemical names specifying the ingredients of each of the chemicals, such as formaldehyde, ethanol, acetic acid, and toluene.

A chemical identification tag 200 is an RFID tag attached to the cover of a chemical container 5 which is kept in the chemical storage facility 1, and the chemical identification tag 200 previously stores the unique identification code of the chemical storage facility 1, in which the chemicals should be stored, and chemical-related information.

Here, the unique identification code of the chemical storage facility 1 is the same as that stored in the storage facility identification tag 100. Meanwhile, the chemical-related information, stored in the chemical identification tag 200, includes unique information about a relevant chemical, such as an item name, a product name, a manufacturing company, a standard, the degree of purity, a storage state, state characteristics (liquid, solid, acid, and basic), and Chemical Abstract Service (CAS) number (CAS number is the international chemical substance number set up by American Chemical Society, and is the specific identifier which enables specific chemical substances to be identified by identifying a molecular structure even though there is no unique chemical importance), usage, inventory quantity, the effective period, and use history.

Further, when a specific chemical is used or replaced, the chemical identification tag 200 can receive information about the use or replacement of the chemical, which is input from a mobile terminal 300 which will be described later, for example, information about the amount of used chemical, information about the inventory quantity of the used chemical, and information about the replaced chemical, and then update the corresponding information. Further, the chemical identification tag 200 can receive the information through an external storage device and then performs an update.

The mobile terminal 300 must be interpreted as including all types of telecommunications terminals, each of which is configured to include an RFID reader, and recognize, receive, and output various information stored in the storage facility identification tag 100 and the chemical identification tag 200 in advance, and configured to be connected to a chemical management server 400, which will be described later, over a network, and transmit and receive data. Therefore, the mobile terminal 300 may include a wired/wireless communication terminal, and employ, for example, a laptop computer, a Personal Digital Assistant (PDA), a handheld Personal Computer (PC), and a portable mobile communication terminal.

In particular, the mobile terminal 300 receives and outputs the unique identification code of the chemical storage facility 1 and the list of chemicals, which are stored in the respective storage facility identification tag 100 in advance, and the unique identification code of the chemical storage facility 1 and the chemical-related information, which are stored in the chemical identification tag 200 in advance. Therefore, a chemical manager can recognize information about the storage location of a specific chemical and the inventory quantity of the chemical, and whether the specific chemical is stored in a desired location in real time. Further, when a new event, for example, the use, replacement, or location change of a specific chemical, occurs, the mobile terminal 300 receives data, such as information about the amount of used chemical, information about the replaced chemical, or information about the changed location of the chemical, transmits the received data to the storage facility identification tag 100 and the chemical identification tag 200, and then performs an update. Further, the mobile terminal 300 is connected to the chemical management server 400, which will be described later, over a network, and configured to transmit and receive data to and from the chemical management server 400.

Meanwhile, with regard to a substance, such as a psychotropic medicine, which is a hazardous substance and a highly virulent substance that requires special management, a measure is required to manage entry and exit times and user information concerning a relevant chemical, and to search for a culprit or make responsibility clear when loss or stealing occurs. For this purpose, in the present invention, a storage facility terminal 10 may be additionally installed in the chemical storage facility 1.

The storage facility terminal 10 operates in conjunction with the door operator (not shown) of the chemical storage facility 1, includes an RFID reader for recognizing a user identification card 20, which is provided with an RFID tag for storing the personal information of a chemical user, in order to allow only an authorized person to open/close the door of the chemical storage facility 1, identifies an authorized person based on recognized information, and then allows the door of the chemical storage facility 1 to be opened or closed. Here, the personal information of the user, which is recognized by the storage facility terminal 10, is transmitted to the chemical management server in real time over the network.

Further, when a specific chemical container 5 is put into or drawn from the chemical storage facility 1, the storage facility terminal 10 detects the entry and exit and then notifies the chemical management server of the entry and exit in real time. That is, the storage facility terminal 10 is provided with an RFID reader for recognizing a chemical identification tag attached to the cover of the chemical container 5. Therefore, when the specific chemical container 5 is drawn from the chemical storage facility 1 and then sent outside, the storage facility terminal 10 detects the exit and transmits an exit signal to the chemical management server. Further, when the chemical container 5, which has been drawn from the chemical storage facility 1, is put into the chemical storage facility 1 again, the storage facility terminal 10 detects the entry and then transmits an entry signal to the chemical management server.

Through the above-described configuration, an entry and exit time for a specific chemical is checked in real time, and the personal information of a user recognized by the storage facility terminal 10 is stored together with the entry and exit time when the corresponding chemical was put into and drawn from the chemical storage facility 1. Therefore, the details of a user concerning the specific chemical and an entry and exit time can be managed, so that the responsibility can be made clear when a chemical is lost or stolen.

The chemical management server 400 is an operation/management server for integrally managing chemicals in a laboratory, which is configured to include a chemical-related information DB for respective chemicals and include an inventory management program, to manage the use details and inventory quantity of used chemicals, to provide a warning when a chemical container 5 is kept in a wrong location by checking the storage location of the chemical container 5 in real time, and to store various pieces of danger management information and provide information about detailed management guidelines for respective chemicals and information about countermeasures when a dangerous situation occurs.

The chemical management server 400 is a high-capacity computer system, including a central processing unit, Random Access Memory (RAM), Read Only Memory (ROM), a terminal interface, and data storage unit. A conventional personal computer or a workstation, having a relatively high-capacity memory and processing ability, may be used as the chemical management server 400.

The network is a wired/wireless communication network which enables both the mobile terminal 300 and the chemical management server 400 to be connected and data communication to be performed therebetween.

FIG. 2 is a block diagram showing the configuration of the chemical management server 400 in detail. As shown in the drawing, the chemical management server 400 includes a chemical information management module 420, a location management module 430, an inventory management module 440, a danger management module 450, an entry and exit management module 460, a communication module 470, and a control module 410. A chemical information DB 425, a location management information DB 435, a danger management information DB 455, and an entry and exit management information DB 465 are constructed therein.

The chemical information management module 420 receives the chemical-related information, stored in a chemical identification tag 200, from the mobile terminal 300 which recognized the chemical identification tag 200, and stores the received chemical-related information in the chemical information DB 425 and then manages it. Further, when a new event, for example, the use, replacement or location change of a specific chemical, occurs, the chemical information management module 420 receives data, such as information about the amount of used chemical or information about the replaced chemical, from the mobile terminal 300, and then updates the chemical information DB 425.

The location management module 430 receives the unique identification code of the chemical storage facility 1 and the list of chemicals stored in the corresponding chemical storage facility 1, the unique identification code of the chemical storage facility 1 and the list of chemicals being stored in the storage facility identification tag 100, and the unique identification code of the chemical storage facility 1 stored in the chemical identification tag 200 from the mobile terminal 300, and stores them in the location management information DB 435 and then manages them.

In particular, the location management module 430 matches the unique identification code of the chemical storage facility 1 and the list of chemicals, both of which are transmitted from the mobile terminal 300 and then stored in the location management information DB 435 when the storage facility identification tag 100 is recognized, with the unique identification and the chemical information, both of which are transmitted from the mobile terminal 300 and then respectively stored in the location management information DB 435 and the chemical information DB 425 when the chemical identification tag 200 is recognized. In the case in which the location of a specific chemical is changed, that is, in the case in which the chemical is not disposed at a desired location, the location management module 430 generates a warning signal. The warning signal is transmitted to the mobile terminal 300 so that the warning signal can be transmitted to a chemical manager who is traveling. Therefore, chemicals can be maintained and managed such that they can always be stored in initially determined locations. Meanwhile, in the case in which the location of a specific chemical is intentionally changed, the location management module 430 receives information data about changed location from the mobile terminal 300, and then updates the location management information DB 435.

The inventory management module 440 recognizes the current inventory quantity, use details, and effective period of each of chemicals using a commercial inventory management program based on data stored in the chemical information DB 425, stores them in the inventory management information DB 445 and manages them. If necessary, the inventory management module 440 includes Continuous Replenishment Programs (CRP). The inventory management module 440 may further include functions of automatically ordering a chemical which is not available in a sufficient quantity, and classifying chemicals, the effective periods of which have expired, into a list of those in need of being discarded and then automatically ordering them when the requirements for the specific chemical are determined and the amount of chemical is insufficient or the effective period of the relevant chemical has expired.

The danger management module 450 performs functions of storing classification reference data for chemicals, which must not be stored together in the same place so as to allow safe storage of the chemicals and danger management, in the danger management information DB 455, and managing it, generating a warning signal when a chemical is stored in the state of not coinciding with the classification reference stored in the danger management information DB 455, and storing information related to countermeasures which are necessary when a dangerous situation occurs in the danger management information DB 455 and then providing the information if necessary. It is preferable that the warning signal and information related to countermeasures, which are necessary when a dangerous situation occurs, be transmitted to the mobile terminal 300 so as to be transmitted to a chemical manager who is traveling in real time.

The chemical classification reference which is stored in the danger management information DB 455 may include the status or characteristics of respective chemicals. That is, an acid chemical is stored together with another acid chemical, and a basic chemical is stored together with another basic chemical. Further, a liquid type chemical is stored together with another liquid type chemical, and a solid type chemical is stored together with another solid type chemical. In other words, an acid chemical must not be stored together with a basic chemical, and a solid type chemical must not be stored together with a liquid type chemical. Therefore, it is preferable to perform danger management in such a way that a list is prepared and stored such that chemicals, which must not be stored together, are associated appropriately based on the status and characteristics of the chemicals.

As another example, it is preferable that chemical classification reference stored in the danger management information DB 455 be based on the reactions between respective chemicals as well as the status and characteristics of the chemicals. For example, formaldehyde intensely reacts with phenol, strong acids, or alkalis, and, when the formaldehyde reacts with hydrochloric acid, a harmful carcinogenic substance, called Bis-chloromethyl is formed. Therefore, it is preferable to perform danger management in such a way that a list is prepared and stored while associating substances (chemicals) which react with each other. Further, it is preferable that the classification reference of the danger management information DB 455 include a reference for separation and storage based on the virulence of chemicals.

Further, in order to prevent cross contamination which may occur when chemicals evaporate and become mixed with each other in the air, it is preferable that danger management be performed in such a way that a list of substances, which must not be kept together, be prepared and stored.

On the other hand, the danger management information DB 455 may be implemented such that a chemical manager can easily obtain treatment information for respective chemicals by storing and managing data, related to the signaling of degrees of danger, emergency measures to be enacted when chemicals are leaked, a processing method to be used when fires occur, notifications for management and use and notifications for discarding for respective chemicals, and by transmitting desired data to the mobile terminal 300 in response to a request from the chemical manager.

Further, it is preferable that the danger management information DB 455 be configured to store information about hazardous substance management degree based on the fire code, and safety guidelines for storage facilities depending on explosiveness, which are suggested by regulations concerning hazardous substance management and high-pressure gases, and to allow the information to be output if necessary, thereby enabling chemical management which coincides with regulations concerning hazardous substances.

The entry and exit management module 460 stores the personal information of a user and an entry and exit time of a specific chemical container 5, which are received from the storage facility terminal 10, in the entry and exit management information DB 465, and then manages them.

The communication module 470 manages data transmission between the chemical management server 400 and the mobile terminal 300, and the control module 410 controls data flow between the respective modules.

Up to now, the configuration of the system for managing chemicals according to the present invention has been described. A method of managing chemicals using the system according to the present invention will be described.

According to the present invention, information about respective chemicals can be easily managed. First, a unique identification code is assigned to each of the chemical storage facilities located in a laboratory, and a storage facility identification tag 100 for storing the unique identification code, is attached to each of the chemical storage facilities 1. Further, the chemical storage facility 1 stores a list of chemicals in the corresponding storage facility identification tag 100 in advance. When a chemical manager recognizes the storage facility identification tag 100, attached to the relevant chemical storage facility 1, using the mobile terminal 300 provided with an RFID, the list of chemicals stored in the corresponding chemical storage facility 1 can be easily checked using the mobile terminal 300.

Further, the chemical identification tag 200 for storing information about a relevant chemical is attached to the cover of each of the chemical containers 5 stored in the chemical storage facility 1. Therefore, the chemical manager can view all information related to the chemical, such as the name of the product, the names of the ingredients, the inventory quantity, and the use details of the corresponding chemical, by recognizing the chemical identification tag 200 using the mobile terminal 300.

Meanwhile, according to the present invention, inventory management for chemicals is possible. An inventory management method using the system for managing chemicals according to the present invention will be described below.

Initially, a plurality of chemicals is kept in each of chemical storage facilities 1 in a specific laboratory based on a predetermined classification reference. A chemical identification tag 200 is attached to the cover of each chemical container 5 for storing a chemical, and information, such as the name, CAS number and inventory quantity of the corresponding chemical, is stored in the chemical identification tag 200 in advance. If inventory quantity varies owing to the use of the relevant chemical, a chemical manager enters information about the varied inventory quantity of the corresponding chemical into a mobile terminal 300. The information about the varied inventory quantity, entered using the mobile terminal 300, is transmitted to the chemical identification tag 200 and then updated. At the same time, the information about the varied inventory quantity is transmitted to a chemical management server 400, and stored and managed in the chemical information DB 425 by the chemical information management module 420. The inventory quantity of each chemical is calculated and then stored by the inventory management module 440.

When inventory quantity varies due to the use of a chemical, the varied information is entered using the mobile terminal 300 in real time, so that data is updated in real time, thereby enabling accurate inventory management to ordinarily be performed.

Further, according to the system for managing chemicals according to the present invention, location management for chemicals is possible. A location management method using the system for managing chemicals according to the present invention will be described below.

When a chemical manager recognizes a storage facility identification tag 100 attached to a specific chemical storage facility 1 using a mobile terminal 300 provided with an RFID reader, the unique identification code of the chemical storage facility 1, which is stored in the storage facility identification tag 100, is output to the mobile terminal 300, and the output information is transmitted to the chemical management server 400. Thereafter, when a chemical identification tag 200 attached to each chemical container which has been kept in the specific chemical storage facility 1, is recognized using the mobile terminal 300, the unique identification code of the chemical storage facility 1, which is stored in the chemical identification tag 200, is output to the mobile terminal 300, and the output information is transmitted to the chemical management server 400 again. The location management module 430 of the chemical management server 400 compares the unique identification code transmitted from the storage facility identification tag 100 with the unique identification code transmitted from the chemical identification tag 200. If, as the results of the comparison, the unique identification codes between the two are different, a warning signal is generated, and the warning signal is transmitted to and output on the mobile terminal 300. Thereafter, the chemical manager searches for a relevant chemical based on the output warning signal, and then moves the corresponding chemical to a chemical storage facility 1 indicated by the unique identification code stored in the chemical identification tag 200.

According to the above-described method, in the case in which a specific chemical deviates from a storage location in the chemical storage facility 1, the chemical can be easily found and then relocated to a desired location, thereby enabling effective location management for chemicals.

Meanwhile, according to the system for managing chemicals according to the present invention, danger management in a laboratory also is possible. A danger management method using the system for managing chemicals according to the present invention will be described below.

When a storage facility identification tag 100 is recognized using a mobile terminal 300, the unique identification code of a relevant chemical storage facility 1 and a list of chemicals stored in the chemical storage facility 1 are output on the mobile terminal 300. The unique identification code and information about the list of chemicals are transmitted to a chemical management server 400, and the danger management module 450 of the chemical management server 400 receives the information, and then determines whether the list of chemicals stored in the corresponding chemical storage facility 1 includes chemicals which must not be kept together, based on the danger management information DB 455. If chemicals which must not be kept together with each other, are kept together with each other in the corresponding chemical storage facility 1, the danger management module 450 transmits a warning signal and a list of the corresponding chemicals which must not be kept together with each other to the mobile terminal 300. Therefore, a chemical manager recognizes that a dangerous situation has occurred in the corresponding chemical storage facility 1 based on the warning signal output from the mobile terminal 300, searches for chemicals output on the mobile terminal 300, and isolates and then keeps them in separate chemical storage facilities 1. Thereafter, with regard to chemicals, the storage locations of which are changed, the chemical manager enters information about the corresponding change using the mobile terminal 300 and updates the storage facility identification tag 100 and the chemical identification tag 200, and sequentially updates DBs constructed in the chemical management server 400.

Further, in the case in which a dangerous situation is generated, for example, one or more chemicals are leaked to the outside by mistake or a fire occurs, if the corresponding chemical identification tag 200 is recognized using the mobile terminal 300, the danger management module 450 searches for various countermeasures stored in the danger management information DB 455, and then transmits the found countermeasures to the mobile terminal 300, thereby enabling effective treatment to be performed based on the found countermeasures when various dangerous situations generated.

As described above, in the case in which chemicals which must not be kept together are kept in the same chemical storage facility 1, this situation is determined as a dangerous situation and a warning is generated. Therefore, a situation, in which the corresponding chemicals react with each other and a dangerous situation occurs, may be prevented in advance, and countermeasures can be rapidly provided even when a dangerous situation actually occurs, thereby enabling effective danger management in a laboratory to be performed.

Further, according to the system for managing chemicals according to the present invention, in the case of a psychotropic medicine or a highly virulent chemical, real-time entry and exit management is possible. A real-time entry and exit management method using the system for managing chemicals according to the present invention will be described below.

In order to perform real-time entry and exit management for chemicals, a storage facility terminal 10 is additionally provided in a chemical storage facility 1 for storing chemicals which require special management. The storage facility terminal 10 is provided with an RFID reader capable of recognizing a chemical identification tag, attached to each chemical container 5, and a user identification cards 20, provided with an RFID tag for storing the personal information of a chemical user.

When a chemical user brings his/her user identification card 20 into contact with the storage facility terminal 10, the storage facility terminal 10 recognizes the user identification card 20 and then determines whether the chemical user is a person who has been authenticated in advance. If, as the results of the determination, the chemical user is determined as a person who has been authenticated in advance, the storage facility terminal 10 performs control on the door operator of the chemical storage facility 1 such that the door is opened and the chemical user can draw a specific chemical from the chemical storage facility 1. Thereafter, if the chemical user brings the user identification card 20 into contact with the storage facility terminal 10 again, the door is closed. Here, the storage facility terminal 10 transmits the personal information of the user recognized based on the user identification card 20, information about the chemical recognized based on the chemical identification tag, which is attached to the chemical container 5, and information about a time, at which the specific chemical is drawn from the chemical storage facility 1, to the chemical management server over a network. The entry and exit management module 460 of the chemical management server stores the received information in the entry and exit management information DB 465 and then manages them. When a chemical is put into the chemical storage facility 1, the same process is performed.

According to the above-described method, in the case of a chemical which requires special management, a time at which a chemical is put into and drawn from the chemical storage facility 1, the corresponding chemical, and a user who put or drew the corresponding chemical into or from the chemical storage facility 1 can be recognized in real time.

According to the above-described present invention, since RFID is used, chemicals are not required to be individually checked with the naked eyes, and barcodes are not required to be scanned for recognition. The information, use details, inventory quantity, and effective period of each of the chemicals which are kept in a laboratory can be integrally managed from a remote place, the storage location of the chemical can be managed, and chemicals which must not be kept together can be kept after being separated and isolated based on the chemical characteristics of the chemicals. Therefore, there are excellent advantages in that a dangerous situation, such as the occurrence of fires or explosions in a laboratory can be prevented in advance, and in that a dangerous situation is concluded at an early stage by providing information about countermeasures when the dangerous situation occurs, thereby enabling overall danger in a laboratory to be managed. Further, with regard to chemicals, such as psychotropic medicines, which require special management, an entry and exit time and the personal information of the user who used a corresponding chemical can be managed in real time, so that the present invention has an excellent advantage in that a culprit can be searched for and the responsibility can be made clear when a chemical is lost or stolen.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for managing chemicals using Radio-Frequency Identification (RFID), comprising:
a storage facility identification tag configured to be attached to each of chemical storage facilities in a laboratory, and to store a unique identification code for identifying the chemical storage facility and a list of chemicals stored in the chemical storage facility, the storage facility identification tag being an RFID tag;
a chemical identification tag configured to be attached to a cover of each of chemical containers kept in the chemical storage facility, and to store the unique identification code of the chemical storage facility, in which relevant chemicals should be kept, and chemical-related information, the chemical identification tag being an RFID tag;
a mobile terminal provided with an RFID reader, and configured to receive and output the unique identification code of the chemical storage facility and the list of the chemicals, stored in the storage facility identification tag, and the unique identification code of the chemical storage facility and the chemical-related information, stored in the chemical identification tag; and
a chemical management server connected with the mobile terminal over a network, and configured to receive information recognized based on the storage facility identification tag and the chemical identification tag, to store the chemical-related information for the chemical, to manage use details and inventory quantity of the chemical, to check a storage location of the chemical container and provide a warning when the storage location of the chemical container is wrong, and to provide a warning and information about countermeasures when a danger situation occurs.

2. The system as set forth in claim 1, wherein the chemical management server comprises:
a chemical information management module for receiving the chemical-related information stored in the chemical identification tag from the mobile terminal which has recognized the chemical identification tag, and storing the chemical-related information in a chemical information Database (DB) and then managing it;
a location management module for receiving the unique identification code of the chemical storage facility and the list of the chemicals in the chemical storage facility, which are stored in the storage facility identification tag, and the unique identification code of the chemical storage facility, which is stored in the chemical identification tag, from the mobile terminal, storing them in a location management information DB and then managing them, and generating a warning signal when a chemical is not located at a desired location;
an inventory management module for managing an inventory quantity, use details and effective period of each of the chemicals based on data stored in the chemical information DB; and
a danger management module for storing classification reference data for chemicals which must not be kept together in a same place for a purpose of safe storage and danger management of the chemicals in a danger management information DB and then managing it, and generating a warning signal when one or more chemicals are kept in a state in which they are inconsistent with the classification reference stored in the danger management information DB.

3. The system as set forth in claim 1, wherein, when a new event, such as use, replacement or location change of a specific chemical, occurs, the mobile terminal receives data, such as an amount of used chemical, information about the replaced chemical or information about a changed location of the chemical, transmits the received data to the storage facility identification tag, the chemical identification tag, and the chemical management server, and then performs an update.

4. The system as set forth in claim 1, wherein the chemical storage facility further comprises a storage facility terminal for recognizing the chemical identification tag and, when the chemical container is put into or drawn from the chemical storage facility, detecting the entry and exit and then notifying the chemical management server of the entry and exit in real time, recognizing a user identification card, provided with an RFID tag for storing personal information of a chemical user, and allowing a door of the chemical storage facility to be selectively opened and closed, and transmitting the recognized personal information of the chemical user to the chemical management server in real time.

5. The system as set forth in claim 4, wherein the chemical management server comprises an entry and exit management module for storing the personal information of the user, which is received from the storage facility terminal, and a time, at which a specific chemical is put into and drawn from the chemical storage facility, in an entry and exit management information DB and then managing them.
